(19) United States
(12) Patent Application Publication
(10) Pub. No.: US 2007/0272012 A1
(43) Pub. Date: Nov. 29, 2007

(54) Portable Liquid Gauge

(76) Inventor: Howard D. Subnick, Tustin, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/420,363

(22) Filed: May 25, 2006

(51) Int. Cl. G01F 19/00

(52) U.S. Cl. 73/426

(57) ABSTRACT

The present invention provides a portable liquid gauge that allows a person to quickly pour a precise amount of liquid directly into a glass. In an embodiment, the liquid gauge comprises a top, four sides, and a base. The top is connected to the base by the sides, which support the top above the base. The top has a plurality of inward semicircular edges, where each semicircular edge is dimensioned to fit around a portion of a glass. The height of the top is chosen so that, when a glass is placed into one of the semicircular edges, the edge aligns with the meniscus of liquid in the glass when a precise amount of the liquid is poured into the glass.

### FIELD

The present invention relates to liquid gauges for pouring a desired amount of liquid into a glass.

### BACKGROUND OF THE INVENTION

A bartender often has to quickly pour liquid, e.g., wine or other drinks, into glasses while trying to pour a desired amount of liquid into each glass. One method of pouring a desired amount of liquid into a glass is for the bartender to first pour the liquid into a measuring glass to get the desired amount of liquid, and then pour the desired amount of liquid from the measuring glass into the glass. A problem with this method is that it takes time to first pour the liquid into the measuring glass and it may be difficult to read the measurement mark on the measuring glass, especially if the mark is not viewed at eye level.

There are liquid pouring spouts for liquor, but they generally only measure 1.5 to 2.5 ounces, which is generally not enough for wine.

At restaurants and parties, a server often has to pour wine from a bottle into several glasses. A problem is that it is difficult for the server to pour the same amount of wine into each glass. The server often has to pour the wine into the glasses, visually inspect the amounts of wine in the glasses, and pour some more wine into glasses that have less wine. This process of pouring and re-pouring wine to make sure that the glasses have the same amount of wine can be time consuming.

### SUMMARY OF THE INVENTION

The present invention provides a portable liquid gauge that allows a person to quickly pour a precise amount of liquid directly into a glass.

In an embodiment, the liquid gauge comprises a top, four sides, and a base. The top is connected to the base by the sides, which support the top above the base. The top has one or more inward semicircular edges, where each semicircular edge is dimensioned to fit around a portion of a glass. The height of the top is chosen so that, when a glass is placed into one of the semicircular edges, the edge aligns with the meniscus of liquid in the glass when a precise amount of the liquid is poured into the glass.

Therefore, the liquid gauge allows a person to quickly pour a precise amount of liquid directly into the glass by placing the glass into one of the semicircular edges, and pouring liquid into the glass until its meniscus reaches the semicircular edge. Further, because the semicircular edge is relatively large, it is easy for a person to visualize when the meniscus of the liquid in the glass reaches the semicircular edge, even when not viewed at eye level.

In one embodiment, the liquid gauge has four back-to-back semicircular edges on the top. In another embodiment, the liquid gauge has two side-by-side semicircular edges on the top. The liquid gauge can have any number of semicircular edges. Multiple semicircular edges allow a person to quickly pour precise amounts of liquid into several glasses.

Other systems, methods, features and advantages of the invention will be or will become apparent to one with skill in the art upon examination of the following figures and detailed description.

### BRIEF DESCRIPTION OF THE DRAWINGS

FIG. 1 shows a liquid gauge with four inward semicircular edges arranged back-to-back according to an embodiment of the invention.

FIG. 2 shows a liquid gauge with two inward semicircular edges arranged side-by-side according to an embodiment of the invention.

FIG. 3 shows a top view of the liquid gauge in FIG. 2 with a glass placed into one of the semicircular edges.

FIG. 4 shows a cross-sectional view of the liquid gauge and the glass in FIG. 3 taken along line 4-4.

### DETAILED DESCRIPTION

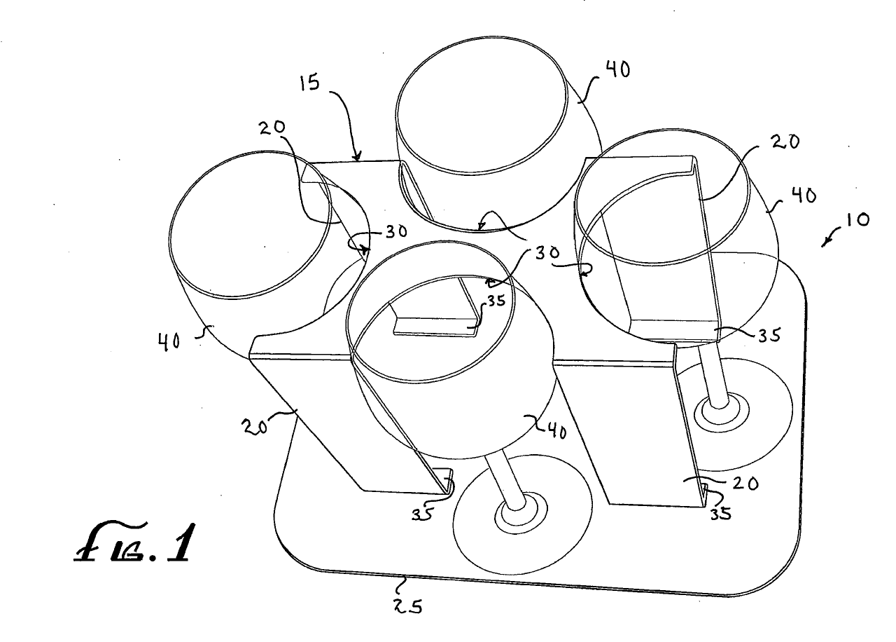

FIG. 1 shows a portable liquid gauge 10 according to an embodiment of the invention. The liquid gauge comprises a top 15, four sides 20, and a base 25. The top 15 is connected to the base 25 by the four sides 20, which support the top 15 above the base 25. The top 15 has four inward semicircular edges 30. Each inward semicircular edge 30 is dimensioned to fit around half the circumference of a glass, e.g., a Brandy snifter, wine glass, champagne flute, or the like. The height of the top 15 above the base 25 is chosen to match on a particular type of glass and a desired amount of liquid in the glass, as explained below. The liquid gauge 10 further includes support joints 35 on the bottom of the sides 20 for joining the sides 20 to the base 25.

Preferably, the top 15, sides 20 and base 25 of the liquid gauge 10 are made of stainless steel, which cleans quickly and easy, and resists staining and the absorption of foreign liquids. The stainless steel may be a 304 grade stainless steel with a number four finish. A mirror or polished finish may also be used. Other materials may be used for the liquid gauge 10 including plastic or another metal.

The top 15 and sides 20 are preferably made from a single sheet of stainless steel that is cut to form the inward semicircular edges 30 and bent to form the four sides 20 and the support joints 35. The stainless steel is preferably cut with a laser and bent hydraulically to ensure fine precision in the construction of the gauge. By making the top 15 an integral part of the sides 20, the entire unit is strengthened. The support joints 35 are preferably welded to the base 25 to strongly join the sides 20 to the base 25.

The base 25 preferably extends out at least two inches passed the sides 20 to prevent tipping of the gauge. The corners of the base 25 are radiused or rounded for safety purposes, e.g., to prevent sharp corners. The upper and lower surfaces of the base 25 are preferably flat to keep the gauge level when placed on a level surface, and to keep glasses placed on the base 25 level. The base 25 is preferably flat with no supports on the bottom such as legs or bumpers. This helps keep the gauge completely level.

To pour a precise amount of liquid into a glass, the glass is placed on the base 25 so that one of the semicircular edges 30 fits around the glass. In the example shown in FIG. 1, each semicircular edge 30 fits around the bulb portion of a stemmed glass 40. Liquid is then poured into the glass until the meniscus (the curved upper surface of a column of liquid) aligns with the semicircular edge 30. The height of the top 15 is chosen so that the edge 30 aligns with the meniscus of the liquid in the glass when a desired amount of liquid is poured into the glass.

Therefore, the liquid gauge allows a person to quickly pour a precise amount of liquid directly into the glass by placing the glass into one of the semicircular edges 30, and pouring liquid into the glass until its meniscus reaches the semicircular edge 30. Further, because each semicircular edge 30 is relatively large, it is easy for a person to visualize when the meniscus of the liquid in the glass reaches the semicircular edge 30, even when not viewed at eye level. Further, the semicircular edge can be easily viewed through the glass, as shown in FIG. 1.

The liquid gauge 10 in FIG. 1 has back-to-back semicircular edges 30 that allows a person to quickly pour precise amounts of liquid into four glasses. To do this, the four glasses 40 are placed on the base 25 so that each semicircular edge 30 fits around half the circumference of one of the glasses 40, as shown in FIG. 1. Liquid is then poured into each of the glasses 40 until the meniscus of the liquid in the glass 40 reaches the respective semicircular edge 30 indicating that a precise amount of liquid has been poured into the glass 40.

The liquid gauge 10 may be custom made to meet the particular needs of a client. For example, the semicircular edges 30 may be custom cut to fit around a client's glass. The height of the gauge 10 may then be chosen so that the semicircular edges 30 correspond to a precise amount of liquid that the client wishes to pour into the glass. In addition, several gauges 10 may be made with each gauge having a different height corresponding to a different amount of liquid. For example, gauges may start measuring at three ounces and increase in one ounce increments to 12 ounces.

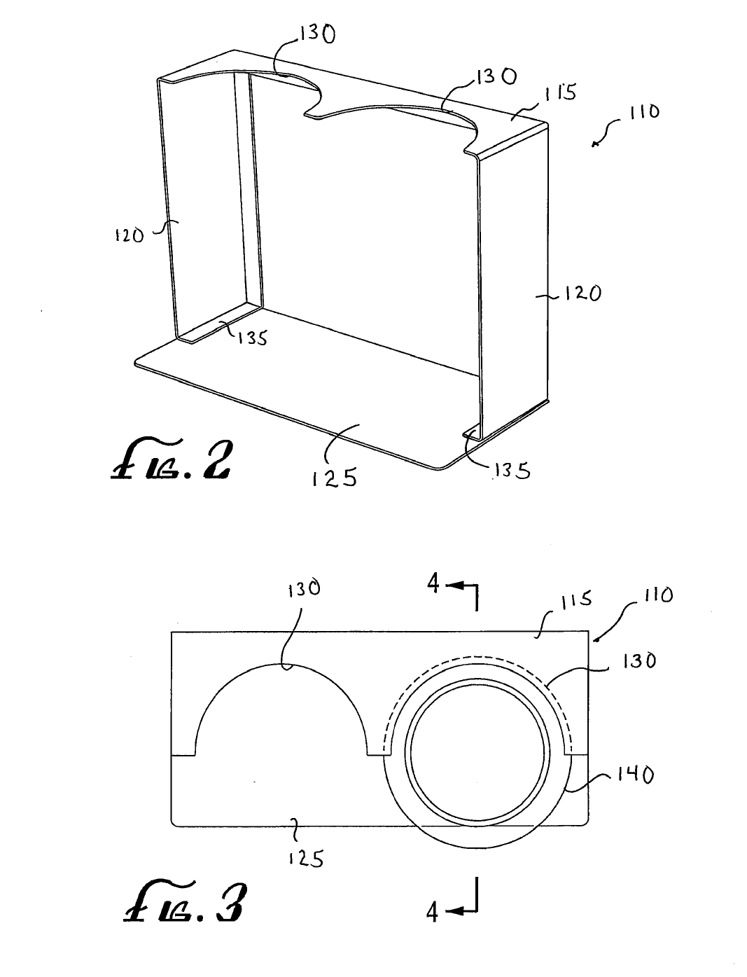

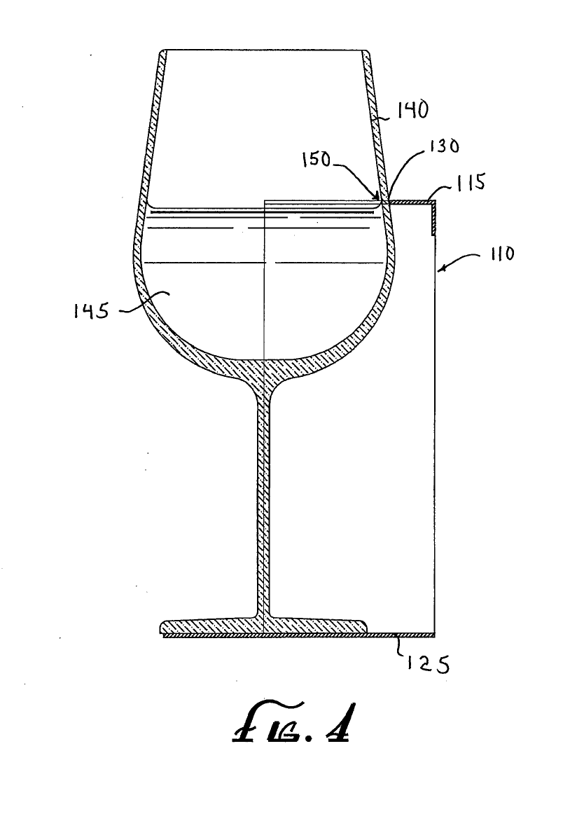

FIG. 2 shows a liquid gauge 110 according to another embodiment with two side-by-side semicircular edges 130 on the top 115. In this embodiment, the gauge 110 includes a base 125 and two sides 120. FIG. 3 shows a top view of a glass 140 placed on the gauge 110 so that one of the semicircular edges 130 fits around half the circumference of the glass 140. FIG. 4 shows a cross-sectional taken along line 4-4 in FIG. 3. FIG. 4 shows liquid 145 poured into the glass 140 until the meniscus 150 of the liquid 145 reaches the semicircular edge 130 indicating that a precise amount of liquid is in the glass 140.

While an embodiment of the present invention has been shown and described, various modifications may be made without departing from the scope of the present invention, and all such modifications and equivalents are intended to be covered. For example, the top of the liquid gauge can have curved edges that fit around less than half the circumference of a glass instead of semicircular edges. Further, the liquid gauge can have any number of semicircular edges and sides. For example, the liquid gauge in FIG. 2 can have one semicircular edge or more than two side-by-side semicircular edges. Although the examples shown in the Figures used stemmed glasses, the liquid gauge can be used to pour precise amounts of liquid into non-stemmed glasses, other glass vessels and jars as well.

What is claimed is:

1. A liquid gauge, comprising:
a top having at least one inward curved edge dimensioned to fit around a portion of a glass;
a base; and
a plurality of sides connected between the top and the base, wherein the sides support the top above the base.

2. The liquid gauge of claim 1, wherein the at least one inward curved edge is semicircular.

3. The liquid gauge of claim 2, comprising at least two semicircular edges arranged side-by-side on the top.

4. The liquid gauge of claim 2, comprising at least two semicircular edges arranged back-to-back on the top.

5. The liquid gauge of claim 1, wherein the top, sides, and base comprise stainless steel.

6. The liquid gauge of claim 5, wherein the top and the plurality of sides are integral.

7. The liquid gauge of claim 1, wherein the base expends at least two inches from the sides and has rounded corners.

8. The liquid gauge of claim 1, wherein the base has flat upper and lower surfaces.

9. A method for pouring a desired amount of liquid into a glass using a liquid gauge, wherein the liquid gauge comprises a top having at least one inward curved edge dimensioned to fit around a portion of the glass, a base, and sides connected between the top and the base for supporting the top above the base, the method comprising:
placing the glass on the base of the gauge so that the curved edge of the gauge fits around a portion of the glass; and
pouring liquid into the glass until a meniscus of the liquid reaches the curved edge.

10. The method of claim 9, wherein the curved edge is semicircular, and further comprising placing the glass on the base so that the edge fits around half a circumference of the glass.

11. The method of claim 10, wherein gauge comprises at least two semicircular edges on the top, and further comprises:
placing the glasses on the base so that each of the semicircular fits around half a circumference of one of the glasses;
pouring liquid into each of the glasses until a meniscus of the liquid reaches the respective semicircular edge.

12. The method of claim 11, wherein the semicircular edges are arranged side-by-side on the top of the gauge.

13. The method of claim 11, wherein the semicircular edges are arranged back-to-back on the top.
